(19) United States
(12) Patent Application Publication
(10) Pub. No.: US 2009/0062415 A1
(43) Pub. Date: Mar. 5, 2009

(54) METHODS OF PRODUCING RIGID POLYURETHANE FOAMS

(75) Inventors: Tomoaki Fukuba, Niihama-shi (JP); Katsuki Kanoh, Osaka-shi (JP); Teruo Hama, Amagasaki-shi (JP); Yuudai Kashiwamoto, Yao-shi (JP); Atsushi Urano, Osaka-shi (JP); Hirokazu Yoshihara, Amagasaki-shi (JP)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/200,085

(22) Filed: Aug. 28, 2008

(30) Foreign Application Priority Data
Aug. 31, 2007 (JP) 2007-226422

(51) Int. Cl. C08G 18/50

(52) U.S. Cl. 521/164; 521/174

(57) ABSTRACT

Methods comprising: providing an aromatic polyisocyanate and a polyol; and reacting the aromatic polyisocyanate and the polyol in the presence of a blowing agent and a catalyst to form a rigid polyurethane foam; wherein the blowing agent comprises water and a hydrocarbon having 3 to 8 carbon atoms; and wherein the polyol comprises a mixture of two or more polyether polyols according to formula (1):

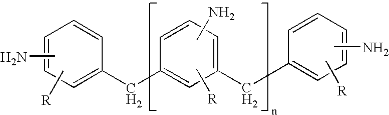

wherein each R independently represents a hydrogen atom or an alkyl group having 1 to 6 carbon atoms and n represents an integer of 0 to 5; the mixture of polyether polyols having a mean functionality of 4.5 or more; and wherein the mixture of polyether polyols comprises 50 to 70% by weight of a compound of formula (1) wherein n=0 is and 30 to 50% by weight of a compound of formula (1) wherein n≧1; and wherein the mixture of polyether polyols comprises 2.5% by weight or more a compound of formula (1) wherein n=4, all percentages by weight based on the mixture of polyether polyol.

### BACKGROUND OF THE INVENTION

A rigid polyurethane foam utilized as a thermal insulator is generally required to have excellent thermal insulation properties (e.g., low thermal conductivity) and, also adhesion to a member to be bound and small dimensional change (e.g., dimensional stability) from necessity as a member contributing to structural strength for a freezer, refrigerator, building material or the like, and particularly high compression strength.

In production of rigid polyurethane foams, it is necessary to use a blowing agent. As the blowing agent, hydrochlorofluorocarbons (hereinafter referred to as “HCFC”) and hydrofluorocarbons (hereinafter referred to as “HFC”) have been used. However, HCFC are generally no longer usable because they are believed to be at least partly responsible for depletion of the ozone layer, and HFC are similarly unused as they are believed to have a larger global warming potential than carbon dioxide.

From a standpoint of global environmental protection, a production method for rigid polyurethane foams using blowing agents other than HCFC and/or IFC, such as, for example, hydrocarbons, e.g., cyclopentane, and water could be beneficial.

However, in the case of using hydrocarbons, particularly cyclopentane, as a blowing agent, the solvent effect (solubility) with respect to a polyurethane resin such as rigid polyurethane foam is large, and resulting strengths like compression strength and dimensional stabilities of rigid polyurethane foam tend to be lowered in comparison with those of HCFC or HFC with the same density. When trying to obtain similar strength and dimensional stability as in HCFC or HFC by using cyclopentane as a blowing agent for a rigid urethane foam molded part, it becomes necessary to heighten the density by increasing the filling amount. Increase in density is not preferable because it causes a factor of deteriorating thermal insulation properties (thermal conductivity) as well as leading to increased production costs. As a result, it becomes necessary to use more rigid polyurethane foam to achieve similar insulation values when using cyclopentane as the blowing agent.

Further, it is thought that the low mutual solubility of hydrocarbon and a polyol obtained by addition of an alkylene oxide adopting an active hydrogen compound having a hydroxyl group or an amino group that has been used in production of rigid polyurethane foam as an initiator lowers the compression strength and adhesion strength to a surface member to be bound.

In the case where water is used alone or in a large amount as a blowing agent, it is not preferable because there is a tendency of deterioration in thermal insulation properties (thermal conductivity) and adhesion to a member as well.

In Japanese Unexamined Patent Publication Sho57-18720, the entire contents of which are hereby incorporated by reference herein, there is described a production method of rigid polyurethane foam with excellent impact resistance and heat resistance utilizing an alkylene oxide adduct of 4,4′-diaminodiphenylmethane or tolylenediamine. However, a polyol based on diaminodiphenylmethane or tolylenediamine as an initiator is rather not preferable from the point of providing a rigid polyurethane foam with strength due to a functionality of 4.0.

Japanese Unexamined Patent Publication Sho61-69825, the entire contents of which are hereby incorporated by reference herein, describes that in the case where a rigid polyurethane foam is produced by using an active hydrogen compound containing a polyol that an alkylene oxide is added to a mixture of diphenylmethanediamine and polymethylene polyphenylamine, the rigid polyurethane foam is excellent in low-temperature dimensional stability and low in thermal conductivity. However, compression strength and other properties are not sufficient.

Japanese Unexamined Patent Publication Hei 5-186553, the entire contents of which are hereby incorporated by reference herein, describes that in the case where a rigid polyurethane foam is produced by using an active hydrogen compound containing a polyol that an alkylene oxide is added to a mixture of diphenylmethanediamine and polymethylene polyphenylamine, the rigid polyurethane foam is excellent in thermal insulation properties, strength of mechanical properties and low-temperature dimensional stability. However, compression strength is not sufficient.

Thus, prior production methods for rigid polyurethane foams using cyclopentane and water as a blowing agent, are not sufficient for maintaining thermal insulation properties (low thermal conductivity) as a thermal insulator and having particularly high compression strength.

### BRIEF SUMMARY OF THE INVENTION

The present invention relates to production methods for preparing rigid polyurethane foams which can be utilized as thermal insulators for freezers, refrigerators, building materials, and the like. It particularly relates to rigid polyurethane foam with excellent compression strength produced by a blowing agent comprising cyclopentane and water.

The present invention provides production methods for preparing rigid polyurethane foams using a blowing agent comprising cyclopentane and water wherein the rigid polyurethane foams maintain thermal insulation properties (low thermal conductivity) as a thermal insulator and have particularly high compression strength.

The various embodiments of the present invention provide the combination of thermal insulation and high compression strength, even in the case of using cyclopentane and water as a blowing agent in a production method of rigid polyurethane foam by using, as part of a polyol reactant (for reaction with a polyisocyanate), a mixture of two or more polyether polyols (also referred to herein as “a polyether polyol” or “the polyether polyol”) which can be obtained by adding an alkylene oxide to a mixture of diaminodiphenylmethane and polymethylene polyphenylamine (hereinafter referred to as “mixture of MMDA and PMDA”), the mixture of polyether polyols having a specific composition.

One embodiment of the present invention includes methods which comprise: providing an aromatic polyisocyanate and a polyol; and reacting the aromatic polyisocyanate and the polyol in the presence of a blowing agent and a catalyst to form a rigid polyurethane foam; wherein the blowing agent comprises water and a hydrocarbon having 3 to 8 carbon atoms; and wherein the polyol comprises a mixture of two or more polyether polyols according to formula (1):

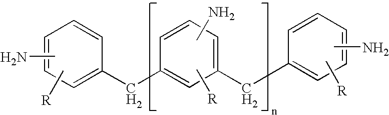

wherein each R independently represents a hydrogen atom or an alkyl group having 1 to 6 carbon atoms and n represents an integer of 0 to 5; the mixture of polyether polyols having a mean functionality of 4.5 or more; and wherein the mixture of polyether polyols comprises 50 to 70% by weight of a compound of formula (1) wherein n=0 is and 30 to 50% by weight of a compound of formula (1) wherein n≧1; and wherein the mixture of polyether polyols comprises 2.5% by weight or more a compound of formula (1) wherein n=4, all percentages by weight based on the mixture of polyether polyol.

The present invention provides a production method of rigid polyurethane foam from an aromatic polyisocyanate, a polyol, a blowing agent and a catalyst, comprising: using the blowing agent of a hydrocarbon having 3 to 8 carbon numbers and water; and in part of the polyol, a polyether polyol of a mean functionality of 4.5 or more obtained by adding an alkylene oxide to a mixture of diaminodiphenylmethane and polymethylene polyphenylamine where n=0 is 50 to 70% by weight and n≧1 is 30 to 50% by weight, wherein the amount of a compound of n=4 relative to said mixture is 2.5% by weight or more, as expressed by the following formula:

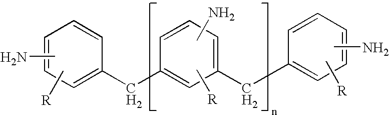

Methods for producing rigid polyurethane foam according to the various embodiments of the present invention can provide a rigid polyurethane foam with particularly high compression strength maintaining thermal insulation properties (low thermal conductivity) as a thermal insulator using an earth-conscious blowing agent comprising cyclopentane and water. The compression strength of the resulting rigid polyurethane foams can be advantageously increased by 7 to 20% compared with that in the case where the amount of a compound of n=4 is 2.0% by weight or less. The density of resulting rigid polyurethane foams is preferably in the range of 29 to 32 kg/m³.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “a polyisocyante” herein or in the appended claims can refer to a single polyisocyanate or more than one polyisocyanate. Additionally, all numerical values, unless otherwise specifically noted, are understood to be modified by the word “about.”

An aromatic polyisocyanate is an organic polyisocyanate having at least 2 isocyanate groups. As the aromatic polyisocyanate, suitable examples include tolylene diisocyanate (2,4′TDI and 2,6 TDI), 4,4′-diphenylmethane diisocyanate (4,4′ MDI), 2,4′-diphenylmethane diisocyanate (2,4′ MDI), polymethylene polyphenylpolyisocyanate polymeric MDI), and modified polyisocyanates obtained by modification thereof. As the modified polyisocyanates, suitable examples include those modified with urethane modification of reaction with an active hydrogen compound, carbodiimide modification, isocyanurate modification, buret or allophanate modification, these organic polyisocyanates may be used alone, or in a mixture thereof. The content percentage of isocyanate groups in an aromatic polyisocyanate is 20 to 48% by weight, and preferably 25 to 40% by weight.

Among these, polymeric MDI is preferable. As the composition of polymeric MDI, it is particularly preferable that 4,4′ MDI in polymeric MDI is 41 to 46% by weight, 2,4′ MDI is 2 to 6% by weight, and the component of multinuclear complex of trinuclear complex or more is 48 to 57% by weight.

As part of polyol, there is used a mixture of two or more polyether polyols which can be obtained by adding an alkylene oxide to a mixture of MMDA and PMDA shown in the following formula:

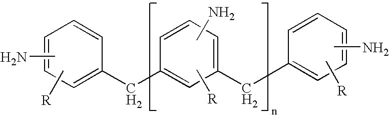

wherein R is a hydrogen atom or an alkyl group having 1 to 6 carbon numbers, a plurality of Rs each may be the same or different, and n is an integer of 0 to 5.

This polyether polyol can be obtained by a method generally used industrially, for example, it is obtained by adding an alkylene oxide to a mixture of MMDA and PMDA in the presence of an alkali catalyst.

As the alkylene oxide, ethylene oxide and propylene oxide having 2 to 4 carbon numbers are suitable examples. Addition of ethylene oxide, propylene oxide alone or concomitant use thereof is preferable. In particular, preferable is one that addition of ethylene oxide is carried out first, and next propylene oxide is added on a terminal to be added with propylene oxide.

When there is much diaminodiphenylmethane shown by n=0 in a mixture of MMDA and PMDA, compression strength of the resulting rigid polyurethane foam becomes too low to suit to actual use. On the other hand, when polymethylene polyphenylamine of n≧1 (also called high-dimensional condensate/multinuclear complex component other than n=0) in the mixture becomes more than necessary, viscosity of the resulting polyether polyol becomes too high, which causes the lowering of workability such as less production efficiency at the production site of rigid polyurethane foam. Further, it is not preferable because thermal conductivity tends to increase.

It is preferable to use a polyether polyol of a mean functionality of 4.5 or more obtained by adding an alkylene oxide to a mixture of MMDA and PMDA where n=0 is 50 to 70% by weight and n≧1 is 30 to 50% by weight. It is particularly preferable that n=0 is 55 to 65% by weight and n≧1 is 35 to 45% by weight.

Further, preferable is an adjusted one such that the amount of a compound of n=4 relative to a mixture of MMDA and PMDA is 2.5% by weight or more (an example of the preferable range is 2.5 to 6.0% by weight (n≧1 other than n≧4 is 24 to 47.5% by weight)). An example of further more preferable range is 3.0 to 5.0% by weight (n≧1 other than n=4 is 25 to 46.5% by weight).

A rigid polyurethane foam having high compression strength is obtained by using a polyether polyol of a mean functionality of 4.5 or more obtained by adding an alkylene oxide to a mixture of MMDA and PMDA where n=0 is 30 to 70% by weight and n≧1 is 30 to 50% by weight, further, wherein the amount of a compound of n=4 relative to a mixture of MMDA and PMDA is 2.5% by weight or more.

Further, when n=4 is 2.5 to 6.0% by weight (more preferable range is 3.0 to 5.0% by weight), it is further preferable because thermal conductivity necessary for a thermal insulator is maintained 21.0 mW/m·K or less.

A hydroxyl value of a polyether polyol obtained by adding an alkylene oxide to a mixture of MMDA and PMDA is suitably 250 to 550 mgKOH/g, and particularly preferably 300 to 450 mgKOH/g.

As a polyol other than the polyether polyol obtained from a mixture of MMDA and PMDA, there is mentioned a polyether polyol obtained by adopting a compound having at least 2 active hydrogen-containing functional groups such as a hydroxyl group and an amino group or a mixture of 2 kinds or more thereof as an initiator and by adding an alkylene oxide thereto.

A hydroxyl value of other polyol is suitably 300 to 600 mgKOH/g, and particularly preferably 350 to 550 mgKOH/g.

As a polyol, there are a polyether polyol, polyester polyol and polyhydric alcohol.

It is preferable to use at least one kind of polyether polyol or, in addition thereto as a major component, concomitantly use a polyester polyol, polyhydric alcohol, alkanolamine or polyamine.

As the polyether polyol, preferable is a polyether polyol obtained by adding an alkylene oxide such as propylene oxide and ethylene oxide to a polyhydric alcohol, sugars, alkanolamine, and a polyamine other than diaminodiphenylmethane and polymethylene polyphenylamine.

Further, as the polyol, there can be used a polyether polyol that fine particles of polymer are dispersed in a polyether polyol.

As the polyester polyol, there is a condensation type polyol composed of a polyhydric alcohol and a polyvalent carboxylic acid, or a ring-opening polymerization type polyol of cyclic ester.

As the polyhydric alcohol being an initiator, there are ethylene glycol, propylene glycol, glycerin, trimethylolpropane, pentaerithritol, and the like. As the sugars, there are sucrose, sorbitol, and the like. Further, the alkanolamine includes diethanolamine, triethanolamine, and the like. The polyamine includes ethylenediamine, tolylenediamine, and the like.

Among these initiators, in particular, a polyether polyol that alkanolamine is an initiator is preferable to blend with a polyether polyol obtained from MMDA and PMDA and reduce the viscosity. Particularly preferable one is a polyether polyol that diethanolamine is an initiator.

In consideration of workability such as handling of a polyether polyol obtained from MMDA and PMDA, it is preferable that diethanolamine is previously blended with a mixture of MMDA and PMDA before addition of an alkylene oxide to reduce the viscosity of a polyether polyol obtained by a blend of a mixture of MMDA and PMDA and diethanolamine. As the blend ratio (amount) of diethanolamine, it is preferably 25 to 55 parts by weight relative to 100 parts of a mixture of MMDA and PMDA, and particularly preferably 35 to 45 parts by weight.

When the blend ratio of diethanolamine is in the range of 25 to 55 parts by weight, a polyether polyol whose viscosity is suitable for workability at the production site of rigid polyurethane foam is obtained, causing no lowering of workability.

Regarding a polyether polyol obtained from a mixture of MMDA and PMDA, it is preferably used by 5 to 20 parts by weight relative to 100 parts by weight of the total of polyols [namely, a mixture of a polyether polyol obtained from a mixture of MMDA and PMDA, and other polyol (hereinafter referred to as “polyol mixture”)]. In particular, 10 to 15 pars by weight are preferable. It is possible to increase compression strength of rigid polyurethane foam when in the range of 5 to 20 parts by weight.

As the blowing agent, a hydrocarbon having 3 to 8 carbon numbers and water are used. Suitable hydrocarbons include propane, butane, n-pentane, isopentane, cyclopentane, hexane, cyclohexane, and the like. According to need, these may be used in a mixture of 2 kinds or more thereof. Among these, cyclopentane is preferable.

The amount of the blowing agent is preferably 20 to 10 parts by weight relative to 100 parts by weight of the polyol mixture, and particularly preferably 18 to 13 parts by weight.

The use ratio of hydrocarbon to water is suitably 3:1 to 10:1, and a preferable ratio is 5:1 to 8:1. When the use ratio of hydrocarbon to water is in the range of 3:1 to 10:1, it is possible to provide well-balanced performances necessary for a thermal insulator such as compression strength and thermal insulation properties (low thermal conductivity) and adhesion to a member to be bound.

A catalyst is used in reaction of an organic polyisocyanate and a polyol, and there are used a tertiary amine catalyst such as piperazine, triazine and triethylenediamine, and a metal compound based catalyst such as organic tin compound. Further, a multiple catalyst such as metal carboxylate to react isocyanate groups each other are used if necessary. The amount of the catalyst is preferably 0.1 to 4.0 parts by weight relative to 100 parts by weight of a polyol mixture, and more preferably 0.3 to 3.0 parts by weight.

Auxiliaries may be used. An example of the auxiliary is a surfactant to form minute foams, in particular, a silicone surfactant. As other auxiliaries, there are a flame retardant, coloring agent, filler, viscosity reducing agent, and the like. The amount of auxiliary is 50 parts by weight or less relative to 100 parts by weight of a polyol mixture, for example, 0.1 to 10 parts by weight.

A blend ratio of a polyol component to an organic polyisocyanate is adjusted so that an equivalent ratio of an active hydrogen of polyol component to an organic polyisocyanate (NCO index) is 80 to 300, preferably 100 to 200, and further preferably 105 to 125.

As described above, in the production method of rigid polyurethane foam utilized as a thermal insulator, as part of polyol, in a mixture of MMDA and PMDA, n is an integer of 0 to 5, a polyether polyol of a mean functionality of 4.5 or more obtained by adding an alkylene oxide to a mixture of MMDA and PMDA where n=0 is 50 to 70% by weight (preferably 55 to 65% by weight) and n≧1 is 30 to 50% by weight (preferably 35 to 45% by weight), further, wherein a polyether polyol adjusted for the amount of a compound of n=4 relative to a mixture of MMDA and PMDA to be 2.5% by weight or more (preferable range is 2.5 to 6.0% by weight, particularly preferably 3.0 to 5.0% by weight) is used by 5 to 20 parts by weight (particularly preferably 10 to 15 parts by weight) in a polyol mixture, thereby, even if cyclopentane and water are used as a blowing agent, in a rigid polyurethane foam (in particular, density of 29 to 32 kg/m³), a rigid polyurethane foam with a thermal conductivity of 21.0 mW/m·K or less showing a high value by 5 to 20% particularly in 10% compression strength, preferably a rigid polyurethane foam for a thermal insulator is obtained.

The invention will now be described in further detail with reference to the following non-limiting examples.

### EXAMPLES

In the Examples, unless otherwise noted, “part” and “%” mean “part by weight” and “% by weight”, respectively.

A rigid polyurethane foam was produced using each of raw materials shown in the following Table 1. Respective raw materials and evaluation methods of performances are shown as follows.

### Polyols:

Polyol A:

Polyether polyol obtained by adding propylene oxide to a mixture of sucrose and propylene glycol, having a mean functionality (f) of 5.6, hydroxyl value of 380 mgKOH/g, and viscosity of 11000 mPa·s (25° C.).

Polyol B:

Polyether polyol obtained by adding propylene oxide to toluenediamine, having a mean functionality (f) of 4.0, hydroxyl value of 345 mgKOH/g, and viscosity of 11000 mPa·s (25° C.).

Polyol C:

Polyether polyol that n≧1 is 41%, n=4 to a mixture of MMDA and PMDA (MMDA: Diaminodipheynlmathan, PMDA: Polymethylene polyphenylamine) is 3.5% (n=0 is 59%, n≧1 other than n=4 is 37.5%), a mixture of the blended MMDA and PMDA having a mean functionality (f) of 4.8 and diethanolamine is added first with ethylene oxide and subsequently with propylene oxide, having a mean functionality of about 4.1, hydroxyl value of 410 mgOH/g, and viscosity of 13000 mPa·s (25° C.).

Polyether polyol obtained by adding alkylene oxides to a mixture of MMDA and PMDA is contained by 70 parts.

Polyol D:

Polyether polyol that n≧1 is 47%, n=4 to a mixture of MMDA and PMDA is 4.8% (n=0 is 53%, n≧1 other than n=4 is 42.2%), a mixture of the blended MMDA and PMDA having a mean functionality (f) of 5.0 and diethanolamine is added first with ethylene oxide and subsequently with propylene oxide, having a mean functionality of about 4.2, hydroxyl value of 410 mgKOH/g, and viscosity of 13500 mPa·s (25° C.).

Polyether polyol obtained by adding alkylene oxides to a mixture of MMDA and PMDA is contained by 70 parts.

Polyol E:

Polyether polyol that n≧1 is 33%, n=4 is 1.9%, a mixture of the blended MMDA and PMDA having a mean functionality (f) of 4.7 and diethanolamine is added first with ethylene oxide and subsequently with propylene oxide, having a mean functionality of about 4.0, hydroxyl value of 395 mgKOH/g, and viscosity of 11000 mPa·s (25° C.).

Polyether polyol obtained by adding alkylene oxides to a mixture of MMDA and PMDA is contained by 70 parts.

Polyol F:

Polyether polyol obtained by adding propylene oxide to a mixture of toluenediamine and triethanolamine, having a mean functionality (f) of 3.9, hydroxyl value of 410 mgKOH/g, and viscosity of 5000 mPa·s (25° C.).

Polyol G:

Polyether polyol obtained by adding propylene oxide to propylene glycol, having a mean functionality (f) of 2.0, hydroxyl value of 500 mgKOH/g, and viscosity of 60 mPa·s (25° C.).

### Production of Molded Part of Rigid Polyurethane Foam:

In 100 parts of polyol mixture shown in Table 1, 1.9 parts of B8462 (manufactured by Goldschmidt AG) as silicone surfactant; 1.5 parts of Toyocat NP (manufactured by Tosoh Corporation), 0.4 parts of Kaolizer No. 3 (manufactured by Kao Corporation) and 0.7 parts of Kaolizer No. 14 (manufactured by Kao Corporation) as amine catalyst; and 2.3 parts of water and 14 parts of cyclopentane were mixed beforehand (polyol component).

100 parts of polyol component and 134 parts of polymeric MDI of 31.5% in isocyanate group content (Sumidur 44V20 manufactured by Sumika Bayer Urethane Co., Ltd.; NCO index 115) were poured into an aluminum mold with a size of 500×500×50 mm (thickness) adjusted at a temperature of 40° C. using a high-pressure foaming machine to be foamed and cured, in 5 minutes after pouring, demolded to give a molded part (polyol component and polymeric MDI were controlled at a temperature of 20 to 23° C.).

### Performance Evaluation of Rigid Polyurethane Foam (Physical Properties):

The resulting molded part was kept under the condition of 20° C. for 24 hours, and then the measurement of physical properties was conducted as follows.

(1) Core Density

The skin layer of the molded part was removed, which was cut to a rectangular parallelepiped of 40×40×25 mm (thickness), it was calculated (n=10) from the weight of the cut sample and its volume obtained by water displacement.

(2) Compression Strength at 10%

The molded part cut to a rectangular parallelepiped in the same manner as in the measurement of core density (1) was measured (n=10) in accordance with JIS K7220 using a compression tester (an autograph AGS-10KNG model manufactured by Shimadzu Corporation).

(3) Thermal Conductivity

The molded part cut to a rectangular parallelepiped in the same manner as in the measurement of core density (1) was measured (n=1) in accordance with JIS A1412 using a thermal conductivity measuring apparatus (HC-074A model manufactured by Eko Instruments Co., Ltd).

As physical properties of rigid polyurethane foam used as thermal insulators, generally, it is often required that compression strength at 10% is 130 kPa or more, and thermal conductivity is 21.0 mW/m·K or less. As shown in Table 2, the molded parts of rigid polyurethane foam having different core densities (4 kinds in the range of 29 to 32 kg/m³) were made using polyether polyol obtained from the mixture of MMDA and PMDA having the specific composition of the present invention to measure the physical properties of foam.

As a result, in the case of core density of 29.4 (Kg/m³), Examples 1 and 2 have a higher value of compression strength by 9.0 to 17.4% compared with Comparative examples 1 and 2, and also in the case of core density of 30 to 32 (Kg/m³), Examples 1 and 2 have a higher value of compression strength by 7.3 to 19.9% compared with Comparative examples 1 and 2. From this fact, it is known that the value of compression strength of rigid polyurethane foam according to the present invention is increased by 7 to 20% compared with Comparative example in the range of 29 to 32 (Kg/m³) in core density, which indicates a merit that the rigid polyurethane foam according to the present invention can allow the density to be lower than Comparative example in the case where the value of compression strength may be the same as that of Comparative example (conventional product).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

TABLE 1

| | | Part used | | | Comparative | Comparative |
|---|---|---|---|---|---|---|
| | | (part by weight) | Example 1 | Example 2 | example 1 | example 2 |
| Polyol component | Polyol mixture | Polyol A | 50 | ← | 50 | 50 |
| | | Polyol B | 25 | ← | 25 | 25 |
| | | Polyol C | 15 | | | |
| | | Polyol D | | 15 | | |
| | | Polyol E | | | 15 | |
| | | Polyol F | | | | 15 |
| | | Polyol G | 10 | ← | ← | ← |
| | Surfactant | | 1.9 | ← | ← | ← |
| | Catalyst | | 2.6 | ← | ← | ← |
| | Blowing agent | Water | 2.3 | ← | ← | ← |
| | | Cyclopentane | 14 | ← | ← | ← |

| Amount of MMDA/PMDA polyol in polyol mixture | | 10.5 | 10.5 | 10.5 | 0 |
|---|---|---|---|---|---|
| (% by weight) | | | | | |
| Relative to MMDA/PMDA | n = 0 | 59 | 53 | 66 | 0 |
| mixture, amount of n = 0, n ≧ 1 | n ≧ 1 | 37.5 | 42.2 | 32.1 | 0 |
| (other than n = 4), n = 4 | (other than n = 4) | | | | |
| (% by weight) | n = 4 | 3.5 | 4.8 | 1.9 | 0 |

| | | | | |
|---|---|---|---|---|
| Mean functionality (f) of MMDA/PMDA mixed polyol | 4.8 | 5.0 | 4.7 | 0 |

TABLE 2

| | | | | Comparative | Comparative |
|---|---|---|---|---|---|
| Physical properties of rigid polyurethane foam | | Example 1 | Example 2 | example 1 | example 2 |
| 1 | Core density (Kg/m³) | 29.4 | 29.4 | 29.6 | 29.8 |
| | Thermal conductivity (mW/m · K) | 20.9 | 20.9 | 20.3 | 21.0 |
| | Compression strength at 10% compress (kPa) | 133 | 142 | 122 | 121 |
| | Increasing rate of compression strength at 10% | 9.0/9.9 | 16.4/17.4 | — | — |
| | to Comparative example | | | | |
| | 1/Comparative example 2 (%) | | | | |
| 2 | Core density (Kg/m³) | 30.3 | 30.4 | 30.3 | 30.1 |
| | Thermal conductivity (mW/m · K) | 20.8 | 20.9 | 20.4 | 21.0 |
| | Compression strength at 10% compress (kPa) | 151 | 160 | 135 | 141 |
| | Increasing rate of compression strength at | 11.9/7.1 | 18.5/13.5 | — | — |
| | 10% to Comparative example | | | | |
| | 1/Comparative example 2 (%) | | | | |
| 3 | Core density (Kg/m³) | 31.0 | 31.0 | 31.0 | 31.0 |
| | Thermal conductivity (mW/m · K) | 20.7 | 20.9 | 20.7 | 21.1 |
| | Compression strength at 10% compress (kPa) | 161 | 169 | 150 | 142 |
| | Increasing rate of compression strength at | 7.3/13.4 | 12.7/19.0 | — | — |
| | 10% to Comparative example | | | | |
| | 1/Comparative example 2 (%) | | | | |
| 4 | Core density (Kg/m³) | 31.7 | 31.6 | 31.4 | 31.7 |
| | Thermal conductivity (mW/m · K) | 20.9 | 21.0 | 20.5 | 21.2 |
| | Compression strength at 10% compress (kPa) | 172 | 183 | 158 | 157 |
| | Increasing rate of compression strength at | 8.9/9.6 | 15.8/15.9 | — | — |
| | 10% to Comparative example | | | | |
| | 1/Comparative example 2 (%) | | | | |

What is claimed is:

1. A method comprising: providing an aromatic polyisocyanate and a polyol; and reacting the aromatic polyisocyanate and the polyol in the presence of a blowing agent and a catalyst to form a rigid polyurethane foam; wherein the blowing agent comprises water and a hydrocarbon having 3 to 8 carbon atoms; and wherein the polyol comprises a mixture of two or more polyether polyols according to formula (1): 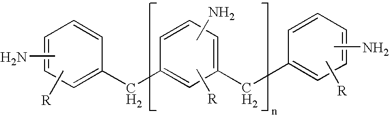
wherein each R independently represents a hydrogen atom or an alkyl group having 1 to 6 carbon atoms and n represents an integer of 0 to 5; the mixture of polyether polyols having a mean functionality of 4.5 or more; and wherein the mixture of polyether polyols comprises 50 to 70% by weight of a compound of formula (1) wherein n=0 is and 30 to 50% by weight of a compound of formula (1) wherein n≧1; and wherein the mixture of polyether polyols comprises 2.5% by weight or more a compound of formula (1) wherein n=4, all percentages by weight based on the mixture of polyether polyol.

2. The method according to claim 1, wherein the mixture of polyether polyols is prepared by reacting an alkylene oxide and a reactant mixture comprising diaminodiphenylmethane and polymethylene polyphenylamine.

3. The method according to claim 1, wherein the hydrocarbon having 3 to 8 carbon atoms comprises cyclopentane.

4. The method according to claim 2, wherein the hydrocarbon having 3 to 8 carbon atoms comprises cyclopentane.

5. The method according to claim 1, wherein the mixture of polyether polyols has a hydroxyl value of 250 to 550 mgKOH/g.

6. The method according to claim 2, wherein the mixture of polyether polyols has a hydroxyl value of 250 to 550 mgKOH/g.

7. The method according to claim 3, wherein the mixture of polyether polyols has a hydroxyl value of 250 to 550 mgKOH/g.

8. The method according to claim 4, wherein the mixture of polyether polyols has a hydroxyl value of 250 to 550 mgKOH/g.

9. The method according to claim 1, wherein the mixture of polyether polyols is present as 5 to 20 parts by weight based on 100 parts by weight of the polyol.

10. The method according to claim 2, wherein the mixture of polyether polyols is present as 5 to 20 parts by weight based on 100 parts by weight of the polyol.

11. The method according to claim 3, wherein the mixture of polyether polyols is present as 5 to 20 parts by weight based on 100 parts by weight of the polyol.

12. The method according to claim 4, wherein the mixture of polyether polyols is present as 5 to 20 parts by weight based on 100 parts by weight of the polyol.

13. The method according to claim 5, wherein the mixture of polyether polyols is present as 5 to 20 parts by weight based on 100 parts by weight of the polyol.

14. The method according to claim 6, wherein the mixture of polyether polyols is present as 5 to 20 parts by weight based on 100 parts by weight of the polyol.

15. The method according to claim 7, wherein the mixture of polyether polyols is present as 5 to 20 parts by weight based on 100 parts by weight of the polyol.

16. The method according to claim 8, wherein the mixture of polyether polyols is present as 5 to 20 parts by weight based on 100 parts by weight of the polyol.

17. The method according to claim 1, wherein the rigid polyurethane foam has a density of 29 to 32 kg/m³ and a compression strength 7 to 20% greater than a rigid polyurethane foam formed by the same method but with a mixture of polyether polyols comprising 2.0% by weight or less of a compound of formula (1) wherein n=4.

18. The method according to claim 2, wherein the rigid polyurethane foam has a density of 29 to 32 kg/m³ and a compression strength 7 to 20% greater than a rigid polyurethane foam formed by the same method but with a mixture of polyether polyols comprising 2.0% by weight or less of a compound of formula (1) wherein n=4.

19. The method according to claim 3, wherein the rigid polyurethane foam has a density of 29 to 32 kg/m³ and a compression strength 7 to 20% greater than a rigid polyurethane foam formed by the same method but with a mixture of polyether polyols comprising 2.0% by weight or less of a compound of formula (1) wherein n=4.

20. The method according to claim 4 wherein the rigid polyurethane foam has a density of 29 to 32 k g/m³ and a compression strength 7 to 20% greater than a rigid polyurethane foam formed by the same method but with a mixture of polyether polyols comprising 2.0% by weight or less of a compound of formula (1) wherein n=4.
